(19) United States
(12) Patent Application Publication
(10) Pub. No.: US 2021/0133558 A1
(43) Pub. Date: May 6, 2021

(54) DEEP-LEARNING MODEL CREATION RECOMMENDATIONS

(71) Applicant: International Business Machines Corporation, Armonk, NY (US)

(72) Inventors: Vijay Arya, Bangalore (IN); Kalapriya Kannan, Bangalore (IN); Sameep Mehta, Bangalore (IN)

(21) Appl. No.: 16/670,690

(22) Filed: Oct. 31, 2019

(51) Int. Cl. G06N 3/08; G06N 3/04; G06N 5/04; G06N 20/00

(52) U.S. Cl. CPC G06N 3/08; G06N 20/00; G06N 5/046; G06N 3/0454

(57) ABSTRACT

One embodiment provides a method, including: accessing historical deployment information for a plurality of deep-learning models, wherein the historical deployment information identifies values for model parameters of a deep-learning model during deployment of the deep-learning model; receiving information related to a target deep-learning model that a developer is creating, wherein the received information identifies components being utilized in the target deep-learning model; determining, by comparing the received information to the historical deployment information, expected values for target model parameters of the target deep-learning model based upon the components utilized within the target deep-learning model; and providing a recommendation for a modification to the target deep-learning model based upon the expected values, wherein the modification comprises a change to at least one component of the target deep-learning model.

### BACKGROUND

Deep-learning models are a type of machine learning model whose training is based upon learning data representations as opposed to task-specific learning. In other words, deep or machine learning is the ability of a computer to learn without being explicitly programmed to perform some function. Thus, machine learning allows a programmer to initially program an algorithm that can be used to predict responses to data, without having to explicitly program every response to every possible scenario that the computer may encounter. In other words, machine learning uses algorithms that the computer uses to learn from and make predictions with regard to data. Machine learning provides a mechanism that allows a programmer to program a computer for computing tasks where design and implementation of a specific algorithm that performs well is difficult or impossible.

### BRIEF SUMMARY

In summary, one aspect of the invention provides a method, comprising: accessing historical deployment information for a plurality of deep-learning models, wherein the historical deployment information identifies values for model parameters of a deep-learning model during deployment of the deep-learning model; receiving information related to a target deep-learning model that a developer is creating, wherein the received information identifies components being utilized in the target deep-learning model; determining, by comparing the received information to the historical deployment information, expected values for target model parameters of the target deep-learning model based upon the components utilized within the target deep-learning model; and providing a recommendation for a modification to the target deep-learning model based upon the expected values, wherein the modification comprises a change to at least one component of the target deep-learning model.

Another aspect of the invention provides an apparatus, comprising: at least one processor; and a computer readable storage medium having computer readable program code embodied therewith and executable by the at least one processor, the computer readable program code comprising: computer readable program code configured to access historical deployment information for a plurality of deep-learning models, wherein the historical deployment information identifies values for model parameters of a deep-learning model during deployment of the deep-learning model; computer readable program code configured to receive information related to a target deep-learning model that a developer is creating, wherein the received information identifies components being utilized in the target deep-learning model; computer readable program code configured to determine, by comparing the received information to the historical deployment information, expected values for target model parameters of the target deep-learning model based upon the components utilized within the target deep-learning model; and computer readable program code configured to provide a recommendation for a modification to the target deep-learning model based upon the expected values, wherein the modification comprises a change to at least one component of the target deep-learning model.

An additional aspect of the invention provides a computer program product, comprising: a computer readable storage medium having computer readable program code embodied therewith, the computer readable program code executable by a processor and comprising: computer readable program code configured to access historical deployment information for a plurality of deep-learning models, wherein the historical deployment information identifies values for model parameters of a deep-learning model during deployment of the deep-learning model; computer readable program code configured to receive information related to a target deep-learning model that a developer is creating, wherein the received information identifies components being utilized in the target deep-learning model; computer readable program code configured to determine, by comparing the received information to the historical deployment information, expected values for target model parameters of the target deep-learning model based upon the components utilized within the target deep-learning model; and computer readable program code configured to provide a recommendation for a modification to the target deep-learning model based upon the expected values, wherein the modification comprises a change to at least one component of the target deep-learning model.

A further aspect of the invention provides a method, comprising: accessing prediction logs of a plurality of deployed neural network models, each deployed neural network model comprising a plurality of components, wherein the prediction logs identify latency values for each of the plurality of deployed neural network models; building, from the prediction logs, machine learning latency models that predict latency values for components of neural network models; receiving, from a neural network developer, a target neural network model; identifying components of the target neural network; estimating latency values for each of the components of the target neural network model utilizing the machine learning latency models; and providing a recommendation to the neural network developer regarding components to utilize within the target neural network based upon the estimated latency values.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of recommending components for a deep-learning model before deployment of the model based upon expected parameter values utilizing historical parameter values of deployed deep-learning models.

FIG. 2 illustrates an example system architecture for recommending components for a deep-learning model before deployment of the model based upon expected parameter values utilizing historical parameter values of deployed deep-learning models.

FIG. 3 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

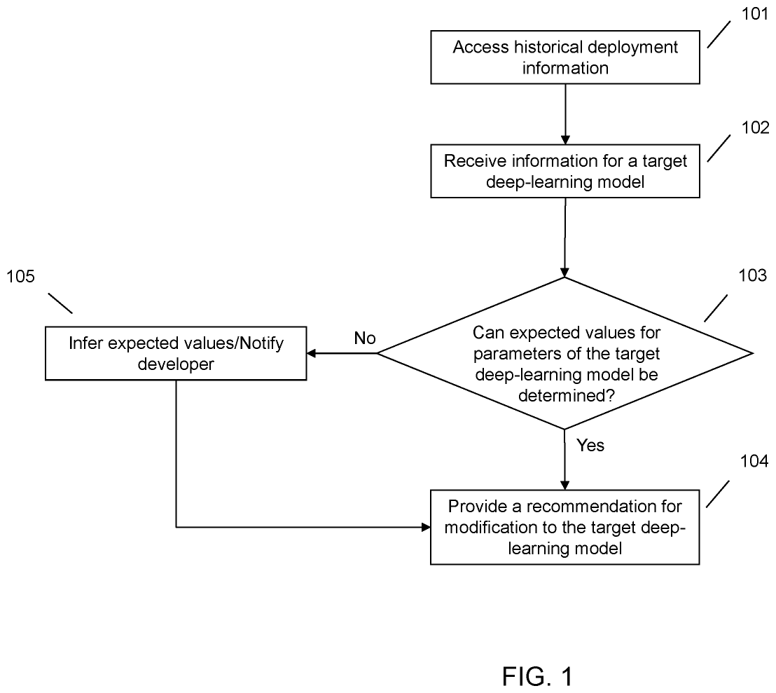

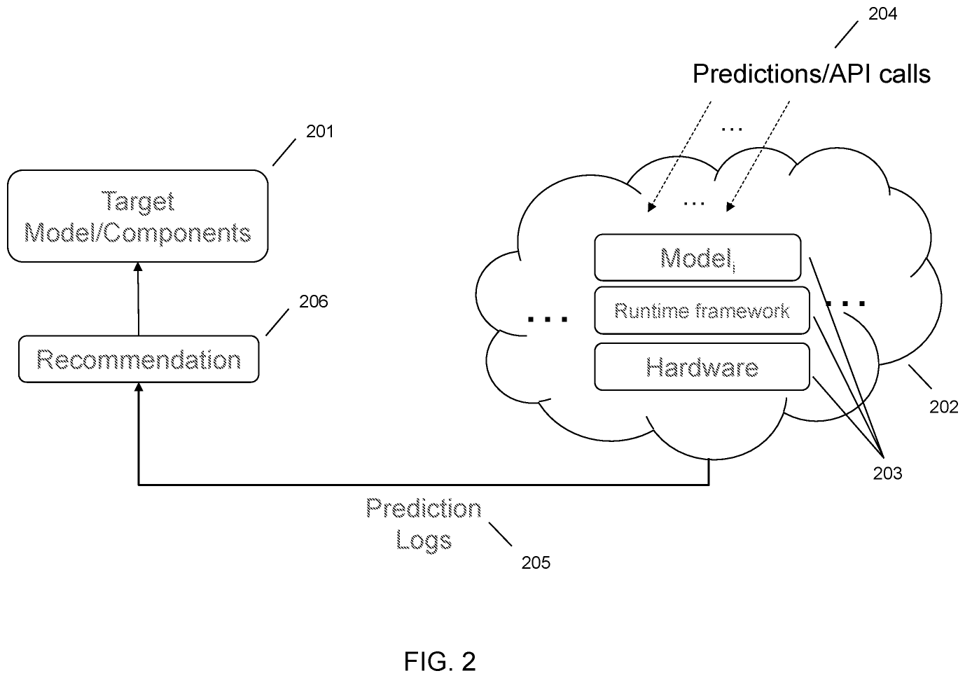

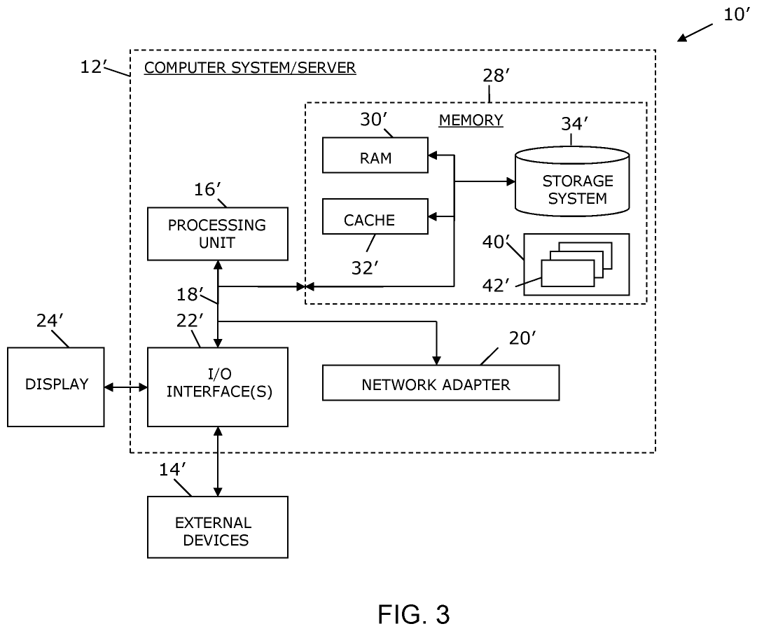

Specific reference will be made here below to FIGS. 1-3. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, most if not all of the process steps, components and outputs discussed with respect to FIGS. 1-2 can be performed or utilized by way of a processing unit or units and system memory such as those indicated, respectively, at 16′ and 28′ in FIG. 3, whether on a server computer, a client computer, a node computer in a distributed network, or any combination thereof.

Deep-learning models are generally manually created by one or more developers. Thus, generation of a deep-learning model is very time consuming and requires significant expertise in not only coding the deep-learning model, but also the domain that the deep-learning model is being developed for. Many models are very complex and may be based upon a combination of different models and/or layers/function modules that each performs a particular function. For example, a deep-learning model may be created from a layer/function module that performs an embedding function, a layer/function module that performs a decoding function, and a layer/function module that performs a pooling function. These layers/function modules may then be integrated into a deep-learning model that performs a more complex function. The generation and selection of layers, architecture types, hardware components, and other components for a deep-learning model is very time consuming.

Generally, as a developer is developing a deep-learning model, the developer spends a significant amount of time training the model to make it as accurate as possible. Thus, the main focus of the developer during development is accuracy. However, when the model is deployed, accuracy is not the only parameter of the model that affects the performance of the model. One parameter that is important and that becomes evident during deployment is latency. Latency is the length of time that it takes the model to return a result, for example, a prediction, explanation for a prediction (explainability), and the like. As models become more complex, the latency may increase. For example, a model with a large number of layers may have a higher latency as compared with a model having a smaller number of layers. Additionally, the use of different components (e.g., architecture type, architecture type, training framework, artificial intelligence hardware components, runtime frameworks, etc.) may change the amount of latency of the deep-learning model. Other parameters, such as memory resources, processing resources, accuracy, and the like, may also be affected by different components. For some models or applications high latency, high memory usage, high processing resource usage, and the like, may be unacceptable. However, since accuracy is the main focus during development and training, the developer may not identify problems with the deep-learning model parameters until after the model is deployed, which then causes a significant amount of rework and delay of the deployment of a working model. Additionally, there is no current technique for predicting the values of these parameters, and currently the developer must deploy the model to learn the actual parameter values.

Accordingly, an embodiment provides a system and method for recommending components for a deep-learning model before deployment of the model based upon expected parameter values utilizing historical parameter values of deployed deep-learning models. The system accesses historical deployment information for a plurality of deep-learning models. The historical deployment information may include logs, for example, prediction logs, for deployed deep-learning models. The historical deployment information can be utilized to identify different parameter values for each of the deep-learning models. Additionally, the historical deployment information identifies different components of the deep-learning model. The system receives information related to a target deep-learning model. The target deep-learning model may be a model that a developer is in the process of developing. The information may identify components that are being utilized in the model, applications that the model will be utilized within, goals for parameter values of the model, and the like.

Utilizing the historical deployment information, the system can determine expected values for parameters of the target model. For example, the system can determine the expected latency, processing resources, storage resources, and the like, of the target model. To determine the expected values, the system may compare components of the target model to components within the historical deployment information. Upon finding a matching component that is utilized within one of the deployed models, the system may then identify the value for the parameter of the deployed model. If the component can be found in multiple deployed models, the system may take an average of the parameter values across all the deployed models. Utilizing the deployed model parameter values, the system can make a prediction for the parameter value for the target model. The system can also provide a recommendation for a modification to the target model based upon the predicted or expected parameter values. The modification may include making a change to a component within the target model in order to reduce a parameter value.

Such a system provides a technical improvement over current systems for developing deep-learning models. By utilizing prediction logs of already deployed deep-learning models or neural networks, the described system and method can identify different parameter values for different components that may be utilized in a deep-learning model. The system can then provide a recommendation for a component to be utilized in developing a deep-learning model in order to minimize the parameter values for the target deep-learning model. Also, the system can identify the parameter values for the target deep-learning model so that the developer can decide whether the parameter values are acceptable. Since the parameter value identification and recommendation occurs while the developer is developing the model, the developer can make changes to the model before it is deployed. Since conventional techniques are unable to determine the parameter values until after the model is deployed, the described system and method provides a more proactive model development system. Additionally, since the development system is proactive, the system is more efficient and results in less development time than traditional systems. The proactive system also results in models that will perform as the developer expects, rather than the developer deploying the model and then learning the parameter values as found in conventional development techniques. Thus, the described system provides deep-learning model development that is more efficient and that results in better performing models than conventional model development systems.

FIG. 1 illustrates a method for recommending components for a deep-learning model before deployment of the model based upon expected parameter values utilizing historical parameter values of deployed deep-learning models. At 101, the system may access historical deployment information for a plurality of deep-learning models, also referred to as neural networks and machine-learning models. The deep-learning models used for the historical information are already deployed, for example, on a cloud or network environment. Thus, the logs may be accessible from the cloud or network environment. The historical deployment information may provide information related to the model. For example, the historical deployment information may identify the components of the model (number of layers, layer types/functions, architecture type, training framework, artificial intelligence hardware components, runtime frameworks, etc.), an application that the model is utilized within, a number of predictions made by the model, and the like.

Additionally, the historical deployment information may identify values for different parameters (e.g., latency, processing resource requirements, storage/memory resource requirements, accuracy, etc.) of the model. As each model makes a prediction, provides a result to a query, provides an explanation for a prediction, or the like, the model generates a log, for example, a prediction log. The log identifies how long it took the model to provide the result, also known as the latency of the model. The identification of the length of time may include identifying an overall length of time for the prediction, identifying a length of time it took a particular component of the model to perform the function associated with the component, or the like. The log may also identify other information, for example, the processing and storage/memory resources utilized during a prediction, components of the model, components utilized for a particular prediction, accuracy of the prediction, and the like.

The system may continually monitor deployed models and/or deployed model logs. By utilizing continual monitoring, the system can build machine-learning models for the parameters of the models. For example, the system can build a latency machine-learning model that can identify or predict latency values for models. As another example, the system can generate a processing resource model that can identify or predict processing resource usage values for models. Other models can be generated for other parameters, for example, storage or memory resource usage, accuracy, and the like. The built models can be used to estimate the parameter values for individual layers and different model architectures on different hardware configurations by taking into account input sample dimensions, layer types (dropout, convolution, etc.), layer type hyperparameters, runtime frameworks, hardware components (GPU, TPU, CPU, ASIC, FPGA, etc.), network architectures, and the like.

Since the components of the deployed models are known, the system can identify parameter values of the different components of the model. Identifying parameter values for a particular component may be based on information identified directly from the logs, for example, the logs may directly identify parameter values for a particular component. Alternatively, the system may have to infer parameter values for a particular component utilizing other information included within the logs. One type of inference may be a simple mathematical or deductive type inference. For example, if the system knows parameter values for an overall system having three components and also knows the parameter values for two out of the three components, the system can simply subtract the parameter values for the two components from the overall system parameter value and then assign, by inference, the resulting parameter value difference to the third component.

Another type of inference may include a correlation inference. If the system identifies a first model having some set of components, a second model having a set of components with some overlap with the first model, and another model having a set of components having some overlap with either of the first or second model, and if the system also identifies or knows some parameter values for some of the overlapping components, the system could then perform a correlation to determine the parameter values for some of the components having missing or unknown parameter values. Another type of correlation may be if the system knows parameter values for the same or similar component across multiple deployed models, the system could infer that the same or similar component on a different model would have the same or similar parameter value.

Another technique for inferring parameter values is an estimation inference based upon noise of the prediction. The noise refers to the amount that an overall parameter of a prediction varies as input samples vary. In other words, larger input sample sets may have a slightly longer prediction time than smaller sample sets. This variation in latency would be considered latency noise. This noise variation can be exploited to estimate or infer parameter values for different components within the model.

Knowing the total number of prediction samples and the overall parameter value for the model, the system can infer parameter values for different components within the model. The system assumes that each similar component within the model produces a similar parameter value average, this parameter value average being unknown. The system also does not know the noise variation introduced by each layer. However, by setting the known and unknown values up as an optimization problem and determining the solution, the system can accurately estimate the parameter value for a component, particularly as the number of samples increase. An example optimization problem is:

$$min {‖ E ‖}_{2}$$

$${\sum }_{j = 1}^{m} ( {L}_{j} + {e}_{i j} ) = {N}_{i} ∀ i ( n equations )$$

where i is a sample, j is a particular layer, Lⱼ is the parameter value average, E=[eᵢⱼ] is the matrix of noise variation introduced by a layer corresponding to the ith input sample, and Nᵢ is the network prediction latency for a sample. Under standard assumptions of zero mean noise E, Lⱼ can be accurately estimated with an increasing number of samples.

At 102, the system may receive information related to a target deep-learning model. The target deep-learning model may be a model that a developer is creating or developing. The system may receive the information from a neural network modeling integrated development environment that is used to create neural network models. Alternatively, the developer may provide the information to the system. The received information may identify components that are being utilized in the target deep-learning model. The information may identify the components (e.g., layer types, layer numbers, runtime framework, training framework, architecture type, artificial intelligence hardware components, etc.) that the developer has already included in the model, the components the developer is planning on using, or the components that the developer needs to use in the model. The information may also identify parameter values that the developer wants to meet or exceed, also referred to as target parameter values.

At 103, the system attempts to determine expected parameter values for the target deep-learning model. To make this determination the system compares the components of the target model to the historical deployment information. Specifically, the system attempts to find a component of the target model within the historical deployment information. Once a match is found, the system identifies the parameter value that is found within the historical deployment information. For example, the system may use the parameter value models that were built to estimate the parameter values for the target model components by matching the components of the target model to the components within the parameter value models.

In the event that a target component is not represented within the historical deployment information or the parameter value models, the system can attempt to infer the parameter value at 105 utilizing any of the inference techniques discussed in connection with step 101. Otherwise, the system may notify the developer that a parameter value cannot be identified at 105. If, on the other hand, an expected parameter value can be determined at 103, the system may provide a recommendation for a modification to the target model at 104.

The modification may include making a change to at least one component of the target model. The system may search for various model configurations to identify a best, average, and worst case parameter values. For example, the system may identify which architecture types would result in the best, average, and worst case parameter values. The system may perform a similar analysis for other components. The system may then provide an identification of these components and corresponding parameter values to the user as a recommendation for components to use within the target model. In other words, the system can identify which components would result in particular parameter values, thereby allowing the user to select components to result in target parameter values. The system can also identify components that can be substituted for other components to result in better or desired parameter values.

If the target model already has components included in the model, the system may identify which of these components contributes the most to the resulting parameter values. In other words, a component may be the biggest contributor to a particular parameter value. The system can identify the component that is the biggest contributor and provide that identification to the user. The system can also provide an identification of a substitute component that would result in a better parameter value. The recommendation can occur while the target model is being developed, or in real-time, allowing the developer to create a target model to meet desired target parameter values.

FIG. 2 illustrates an example system architecture for providing recommendations for target models. The system receives the target model and components 201. From models that are already deployed, for example, in a cloud environment 202, the system identifies components 203 of the deployed models, for example, the model type, runtime framework type, hardware configuration/components, and the like. As these deployed models make predictions and receive API calls 204, prediction logs 205 are created. From the prediction logs 205, the system can identify parameter values and make recommendations 206 for components that should be utilized in the target model 201 to result in desired parameter values. These parameters may include latency, including explainability latency, storage/memory resource usage, processing resource usage, accuracy, and the like.

Such a system and method provide a technical improvement over current techniques for developing deep-learning models. Rather than the developer having to deploy a model to learn different parameter values, the developer can receive recommendations for components to utilize in the development of the deep-learning model in order to develop a model with desired parameter values. By receiving these recommendations during the development of the deep-learning model, the developer can develop the model in view of these parameters instead of having to deploy the models to identify the parameter values. Thus, instead of having to deploy the model, learn the parameter values, and then modify the components of the model as with conventional techniques, the described system and method provide a more efficient technique for developing deep-learning models, particularly, deep-learning models that will perform as needed for the application that will utilize each model. Accordingly, the described system and method provides a more efficient and accurate technique for developing deep-learning models that perform as desired by the developer, thereby, resulting in better deep-learning models than those developed using conventional techniques.

As shown in FIG. 3, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
accessing historical deployment information for a plurality of deep-learning models, wherein the historical deployment information identifies values for model parameters of a deep-learning model during deployment of the deep-learning model;
receiving information related to a target deep-learning model that a developer is creating, wherein the received information identifies components being utilized in the target deep-learning model;
determining, by comparing the received information to the historical deployment information, expected values for target model parameters of the target deep-learning model based upon the components utilized within the target deep-learning model; and
providing a recommendation for a modification to the target deep-learning model based upon the expected values, wherein the modification comprises a change to at least one component of the target deep-learning model.

2. The method of claim 1, comprising receiving desired target model parameter values from the developer, wherein the desired parameter values identify target values for the target model parameters.

3. The method of claim 1, wherein the recommendation comprises identifying a substitution of a component of the deep-learning model to a different component having a better historical parameter value.

4. The method of claim 1, wherein the providing a recommendation occurs while the target deep-learning model is being developed.

5. The method of claim 1, wherein the providing a recommendation comprises identifying a component that is the highest contributor to the expected value.

6. The method of claim 1, wherein the comparing comprises (i) identifying a component within the historical deployment information matching a component of the received information and (ii) identifying a value for a target parameter within the historical deployment information.

7. The method of claim 1, wherein the determining comprises inferring an expected value for a target parameter for a particular component based upon a historical parameter value of an overall system comprising a similar component, wherein the parameter value for the similar component is unknown.

8. The method of claim 7, wherein the inferring comprises utilizing an optimization algorithm to predict the expected value for the target parameter by estimating the parameter value using a series of parameter measurements.

9. The method of claim 1, wherein the at least one component comprises at least one of: layers, architecture type, training framework, artificial intelligence hardware components, and runtime frameworks.

10. The method of claim 1, wherein the parameters comprise at least one of: latency, memory resources, processing resources, and accuracy.

11. An apparatus, comprising:
at least one processor; and
a computer readable storage medium having computer readable program code embodied therewith and executable by the at least one processor, the computer readable program code comprising:
computer readable program code configured to access historical deployment information for a plurality of deep-learning models, wherein the historical deployment information identifies values for model parameters of a deep-learning model during deployment of the deep-learning model;
computer readable program code configured to receive information related to a target deep-learning model that a developer is creating, wherein the received information identifies components being utilized in the target deep-learning model;
computer readable program code configured to determine, by comparing the received information to the historical deployment information, expected values for target model parameters of the target deep-learning model based upon the components utilized within the target deep-learning model; and
computer readable program code configured to provide a recommendation for a modification to the target deep-learning model based upon the expected values, wherein the modification comprises a change to at least one component of the target deep-learning model.

12. A computer program product, comprising:
a computer readable storage medium having computer readable program code embodied therewith, the computer readable program code executable by a processor and comprising:
computer readable program code configured to access historical deployment information for a plurality of deep-learning models, wherein the historical deployment information identifies values for model parameters of a deep-learning model during deployment of the deep-learning model;
computer readable program code configured to receive information related to a target deep-learning model that a developer is creating, wherein the received information identifies components being utilized in the target deep-learning model;
computer readable program code configured to determine, by comparing the received information to the historical deployment information, expected values for target model parameters of the target deep-learning model based upon the components utilized within the target deep-learning model; and
computer readable program code configured to provide a recommendation for a modification to the target deep-learning model based upon the expected values, wherein the modification comprises a change to at least one component of the target deep-learning model.

13. The computer readable program code of claim 12, comprising receiving desired target model parameter values from the developer, wherein the desired parameter values identify target values for the target model parameters.

14. The computer readable program code of claim 12, wherein the recommendation comprises identifying a substitution of a component of the deep-learning model to a different component having a better historical parameter value.

15. The computer readable program code of claim 12, wherein the providing a recommendation occurs while the target deep-learning model is being developed.

16. The computer readable program code of claim 12, wherein the providing a recommendation comprises identifying a component that is the highest contributor to the expected value.

17. The computer readable program code of claim 12, wherein the comparing comprises (i) identifying a component within the historical deployment information matching a component of the received information and (ii) identifying a value for a target parameter within the historical deployment information.

18. The computer readable program code of claim 12, wherein the determining comprises inferring an expected value for a target parameter for a particular component based upon a historical parameter value of an overall system comprising a similar component, wherein the parameter value for the similar component is unknown.

19. The computer readable program code of claim 18, wherein the inferring comprises utilizing an optimization algorithm to predict the expected value for the target parameter by estimating the parameter value using a series of parameter measurements.

20. A method, comprising:
accessing prediction logs of a plurality of deployed neural network models, each deployed neural network model comprising a plurality of components, wherein the prediction logs identify latency values for each of the plurality of deployed neural network models;
building, from the prediction logs, machine learning latency models that predict latency values for components of neural network models;
receiving, from a neural network developer, a target neural network model;
identifying components of the target neural network;
estimating latency values for each of the components of the target neural network model utilizing the machine learning latency models; and
providing a recommendation to the neural network developer regarding components to utilize within the target neural network based upon the estimated latency values.
